(19) United States
(12) Patent Application Publication
(10) Pub. No.: US 2022/0007896 A1
(43) Pub. Date: Jan. 13, 2022

(54) MOBILE DISPENSING STATION AND METHOD FOR USING SAME

(71) Applicant: Han San Station LLC, Roswell, GA (US)

(72) Inventors: Michael Maloney, Roswell, GA (US); Timothy Edward Zollers, Atlanta, GA (US)

(21) Appl. No.: 17/371,094

(22) Filed: Jul. 8, 2021

Related U.S. Application Data
(60) Provisional application No. 63/049,332, filed on Jul. 8, 2020.

(51) Int. Cl. A47K 5/12; B05B 15/68; B05B 11/00; B62B 1/26

(52) U.S. Cl. CPC A47K 5/1202; B05B 15/68; B62B 2206/06; B62B 1/26; B62B 2202/50; B05B 11/0037

(57) ABSTRACT

Disclosed herein are a mobile dispensing device and station for dispensing a sanitizing agent. In one aspect, a mobile dispending station can include a container base configured to releasably secure a container, the container base comprising a base housing and a securing mechanism for releasably securing the container in the housing; and a dispenser column comprising: a dispenser system including a dispenser head and switch or pedal, the dispenser system in fluid communication with the container and configured to selectively dispense a predetermined volume of the sanitizing agent from within the container and through the dispenser head, the switch or pedal configured to selectively dispense the sanitizing agent upon activation or actuation, and a column housing for containing the dispenser system. Also disclosed herein are methods of using the disclosed devices and stations.

### CROSS REFERENCE TO RELATED APPLICATIONS

This application claims the benefit of priority to U.S. patent application Ser. No. 63/049,332 filed Jul. 8, 2020, which are herein incorporated in its entirety.

### BACKGROUND

Inadequate infection control can lead to spread of pathogens and can be hazardous to the public health, In the current global environment, infection control has become a particular focus of public health in areas where large numbers of people gather, such as factories, stadiums, schools, hospitals, airports, theaters, and the like. Currently, existing hand sanitizer dispensing systems used for infection prevention and control industry are typically wall-mounted or stand-mounted and only hold a small volume of sanitizing agent. Furthermore, these stand-mounted versions are not very mobile or secure when used in high traffic areas with large crowds.

Accordingly, there remains a need for improved sanitizer dispensing devices and systems that are movable, secure, easy to use, and contain high volumes in order to be able to service large groups of people. This need and other needs are satisfied by the various aspects of the present disclosure.

### SUMMARY

In accordance with the purposes of the disclosure, as embodied and broadly described herein, the disclosure, in one aspect, relates to a mobile dispensing device, system and method for dispensing a sanitizing agent, such as liquid hand sanitizer. This brief overview is provided to introduce a selection of concepts in a simplified form that are further described below in the Detailed Description. This brief overview is not intended to identify key features or essential features of the claimed subject matter. Nor is this brief overview intended to be used to limit the claimed subject matter's scope.

Both the foregoing brief overview and the following detailed description provide examples and are explanatory only. Accordingly, the foregoing brief overview and the following detailed description should not be considered to be restrictive. Further, features or variations may be provided in addition to those set forth herein. For example, embodiments may be directed to various feature combinations and sub-combinations described in the detailed description.

In accordance with the purposes of the disclosure, as embodied and broadly described herein, the disclosure, in one aspect, relates to a mobile dispensing device. In a further aspect, the mobile dispensing device can include a container base configured to releasably secure a container, the container base comprising a base housing and a securing mechanism for releasably securing the container in the housing; and a dispenser column comprising: a dispenser system including a dispenser head and switch or pedal, the dispenser system in fluid communication with the container and configured to selectively dispense a predetermined volume of the sanitizing agent from within the container and through the dispenser head, the switch configured to selectively dispense the sanitizing agent upon activation or actuation, and a column housing for containing the dispenser system.

In another aspect, the disclosure relates to a mobile sanitizing station including a container base assembly configured to releasably secure a container, the container base assembly comprising a base housing and a securing mechanism for releasably securing the container in the housing; and a dispenser column comprising: a dispenser system including a dispenser head and switch or pedal, the dispenser system in fluid communication with the container and configured to selectively dispense a predetermined volume of the sanitizing agent from within the container and through the dispenser head, the switch configured to selectively dispense the sanitizing agent upon activation or actuation, and a column housing for containing the dispenser system.

In further aspects, the disclosure also relates to methods for using the disclosed devices, station and systems, for example, in conjunction with dispensing sanitizing agents.

Additional aspects of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

FIGS. 1A-1H show depictions of a mobile dispensing device in accordance with an embodiment of the present disclosure.

FIG. 2 show a flow diagram of a mobile dispensing device, station, system and method of sanitizing hands in accordance with an embodiment of the present disclosure.

Appendix A shows depictions of various components in a mobile dispensing device in accordance with an embodiment of the present disclosure.

### DETAILED DESCRIPTION

The present disclosure can be understood more readily by reference to the following detailed description of the disclosure and the Examples included therein.

Before the present articles, systems, devices, and/or methods are disclosed and described, it is to be understood that they are not limited to specific manufacturing methods unless otherwise specified, or to particular materials unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present disclosure, example methods and materials are now described.

All publications mentioned herein are incorporated herein by reference to disclose and describe the methods and/or materials in connection with which the publications are cited.

### Definitions

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this disclosure belongs. In this specification and in the claims, which follow, reference will be made to a number of terms which shall be defined herein.

As used in the specification and the appended claims, the singular forms “a,” “an” and “the” include plural referents unless the context clearly dictates otherwise. Thus, for example, reference to “an opening” can include two or more openings.

Ranges can be expressed herein as from one particular value, and/or to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

The terms “first,” “second,” “first part,” “second part,” and the like, where used herein, do not denote any order, quantity, or importance, and are used to distinguish one element from another, unless specifically stated otherwise.

As used herein, the terms “optional” or “optionally” means that the subsequently described event or circumstance can or cannot occur, and that the description includes instances where said event or circumstance occurs and instances where it does not. For example, the phrase “optionally affixed to the surface” means that it can or cannot be fixed to a surface.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

Disclosed are the components to be used to manufacture the disclosed devices, systems, and articles of the disclosure as well as the devices themselves to be used within the methods disclosed herein. These and other materials are disclosed herein, and it is understood that when combinations, subsets, interactions, groups, etc. of these materials are disclosed that while specific reference of each various individual and collective combinations and permutation of these materials cannot be explicitly disclosed, each is specifically contemplated and described herein. For example, if a particular material is disclosed and discussed and a number of modifications that can be made to the materials are discussed, specifically contemplated is each and every combination and permutation of the material and the modifications that are possible unless specifically indicated to the contrary. Thus, if a class of materials A, B, and C are disclosed as well as a class of materials D, E, and F and an example of a combination material, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the articles and devices of the disclosure. Thus, if there are a variety of additional steps that can be performed it is understood that each of these additional steps can be performed with any specific aspect or combination of aspects of the methods of the disclosure.

It is understood that the devices, apparatuses, and systems disclosed herein have certain functions. Disclosed herein are certain structural requirements for performing the disclosed functions, and it is understood that there are a variety of structures that can perform the same function that are related to the disclosed structures, and that these structures will typically achieve the same result.

### Dispensing Device and Station Overview

Consistent with various embodiments and aspects of the present disclosure, provided herein are devices, apparatuses, stations, systems, methods and/or techniques (which may be collectively or individually referred to as the “platform”) for effective sanitization. As briefly described above, the present disclosure relates, in various aspects, to a mobile dispensing device, station, and system for effective sanitization, such as hand sanitization. In further aspects, the present disclosure relates to a mobile dispensing device for dispensing a sanitizing agent.

In one aspect, disclosed herein is mobile dispensing device for dispensing a sanitizing agent, the device comprising: a container base configured to releasably secure a container, the container base comprising a base housing and a securing mechanism for releasably securing the container in the housing; and a dispenser column comprising: a dispenser system including a dispenser head and switch or pedal, the dispenser system in fluid communication with the container and configured to selectively dispense a predetermined volume of the sanitizing agent from within the container and through the dispenser head, the switch configured to selectively dispense the sanitizing agent upon activation or actuation, and a column housing for containing the dispenser system.

In another aspect, disclosed herein is a mobile sanitizing station comprising: a mobile dispensing device for dispensing a sanitizing agent, the device comprising: a container base assembly configured to releasably secure a container, the container base assembly comprising a base housing including wheels and a securing mechanism for releasably retaining the container in the container base housing; and a dispenser column comprising: a dispenser system including a dispenser head and a pedal, the dispenser system in fluid communication with the container and configured to selectively dispense a predetermined volume of the sanitizing agent from within the container and through the dispenser head, the foot pedal configured to selectively dispense the sanitizing agent upon activation or actuation, and a column housing for containing the dispenser system; and a container or compartment configured to hold a sanitizing agent and/or cleaning agent.

According to various aspects of the present disclosure, a device of the present invention comprises a container base or base assembly configured to releasably secure a container. In still further aspects, the container base or base assembly may include a base or base housing with a securing mechanism for releasably retaining the container. In yet further aspects, base or housing may be shaped to conform to the size and/or contour of a container, such as, for example, a five-gallon container. In further aspects, the shaped housing or base may have an established shape, for example, by a preformed housing, or may be a moldable or foldable housing. In still further aspects, a housing may be flat in shape on at least its side walls so that the contact area is shaped so that all or substantially all of the base sides wrap at least 3 sides on the container. All or a portion of a housing may be flat. Additionally, in other embodiments, a proximal side and/or a distal side of the casing may be flat or planar, and the lateral sides of the casing may be shaped. In still further aspects, the lateral sides of the housing may be shaped in any form desired. The housing or base can be any shape, and preferably is in the shape of a three-dimensional polygon and the housing or base walls define an interior space or interior sections for securing the container and certain operating elements of the invention. Any other shape (as used herein, the term shape is used in the broad sense of three-dimensional works) may be employed, so long as the shape is large enough and structured so as to be able to contain the video doorbell and various working components of the invention as more fully disclosed below.

In further aspects, the housing is a generally hollow structure sized to contain the container doorbell and components disposed therein. In still further aspects, the housing is configured and dimensioned to allow a five-gallon container to be securely installed therein. The housing can be a rigid hollow shell or open container having an interior volume. The housing may be constructed such that housing can contain and hold the container and components in a predetermined position relative to an opening on the container for accessing the sanitizing agent. In even further aspects, the housing can be comprised of metal, metal composite, plastic, plastic composite, reinforced plastic, or combinations thereof. In still further aspects, the plastic can comprise polypropylene, impact resistant plastic, or the like. In some aspects, the housing may comprise a plastic housing. In other aspects, the housing may comprise a metal housing. The housing or base (or the components thereof) may comprise at least one planar plate that is molded or folded into an open container allowing for ease of inserting and removing a large container. In some aspects, the base or housing may comprise one or more of: a base pan, a base wrap, a front base pan portion, or a base cover or top, and combinations thereof. In other aspects, the base or housing comprises a base pan, a base wrap, a front base pan portion, and a base cover or top.

In further aspects, the housing may comprise at least one securing mechanism for securely positioning and retaining the container within the container base or housing. The securing mechanism can comprise at least one rotating arm. In still further aspects, the securing mechanism may comprise a plurality of rotating arms. In yet further aspects, the securing mechanism may comprise at least one rotating or hinged cover. In even further aspects, the securing mechanism comprises one or more linking bars for linking one or more rotating arms. In yet further aspects, the securing mechanism may comprise at a plurality of rotating arms are connect by one or more linking bars. The securing mechanism may comprise a hinged cover, and lower and upper rotating arms. In still further aspects, the lower rotating arm is connected with the upper rotating arm by a first linking bar and the upper rotating arm is connected with the hinged cover by a second linking bar. In some aspects, the hinged cover, and lower and upper rotating arms cooperate to secure the container in the base housing. In other aspects, the lower or upper rotating arms are moved, the remaining components of the securing mechanism cooperatively move in the same direction. In further aspects, the rotating arm may be shaped and dimensioned to correspond or substantially correspond to an outer shape and dimensions of the cartridge, for example, a U-shaped member. In still further aspects, a locking mechanism may be included for locking the lower rotating arm with a portion of the base, such as the front base pan portion.

In further aspects, the securing mechanism may also include removable foam material or a clip, cam gripping element, or other mechanical component for keeping the container in a fixed position within the base. To this end, the user may select the appropriate spacer size(s) to match the container model to securely retain the container position within the base housing. In still further aspects, the housing may further comprise one or more openings and/or slots through the housing for fastening or providing access between components, such as for supply lines.

In further aspects, the device of the present is mobile and can be moved from one location to another. In still further aspects, the device can comprise at least two wheels. In still further aspects, the device may comprise two wheels configured to be moved similar or substantially to a dolly or hand truck.

In further aspects, the device may comprise a switch or lever for dispensing or otherwise activating a dispensing system to dispense sanitizing agent from within the container. In still further aspects, the switch may be a foot pedal effective to cause at least a portion of the sanitizing agent within the container to be drawn or pulled into the dispenser system and out of the dispenser head. In some aspects, the switch or lever may comprise a foot pedal. In other aspects, the switch may comprise an actuating mechanism.

In various aspects, the device may comprise a dispenser column or tower comprising a dispenser head. The dispenser column height is adjustable, such as through a telescoping construction or the like. In further aspects, the dispenser column height may be from about 24 to about 48 inches, where the dispenser head is from about 24 to about 48 inches from the ground, such as, for example, from about 30 to about 36 inches from the ground. In further aspects, at least one guard may be disposed on the dispenser column. In some aspects, a plurality of guards may be disposed on the dispenser column. In other aspects, at least one guard disposed on the dispenser column is configured to prevent accidental splashing in children's faces.

In further aspects, the dispenser head may be configured to dispense a predetermined volume or quantity of agent from within the container. In still further aspects, the dispenser head may be in operable communication with a dispensing system, a pump or other similar device that is effective to cause at least a portion of the agent within the container to be drawn or pulled into and out of the dispenser head. In yet further aspects, the dispensing device and/or dispenser head may comprise a flow control component for controlling the flow or form of sanitizing agent begin dispensed, such as dispensing the sanitizing agent as volume of foam. In still further aspects, the flow control component may be configured to control a flow rate of a mixed air/sanitizing agent. In some aspects, the flow control agent may be a nozzle or nozzle insert.

As described above, the dispensing device may further comprise a comprise a guard, such as a flexible casing, that can be positioned over the dispensing head and other location on the column and can be held in place by a bracket, friction, adhesives, fasteners, fitting, or a closure. For example, as shown in the Figures, the flexible guard may be positioned directly over the mouth or opening of the dispenser head where the sanitizing agent is dispensed.

In further aspects, the device may include a dispensing system for dispensing the sanitizing agent. The dispensing system may further comprise at least supply line configured to carry sanitizing agent from within the container into a dispenser head. The supply line may be in fluid communication with the sanitizing agent. In still further aspects, the dispensing system may include a container cap with pick-up supply line traveling therethrough. The device may be configured to tilt the container effective to move the sanitizing agent towards the supply line and/or pick-up hose. In further aspects, a flow control component may be incorporated, which may be in fluid communication with the container, and configured to control a flow rate or volume of sanitizing agent dispensed. In still further aspects, the dispensing head may comprise an atomizing-type nozzle. In some aspects, the device may be configured to dispense atomized sanitizing agent. In other aspects, the device may be configured to dispense foaming sanitizing agent. In further aspects, device may be configured to dispense from about 0.1 ml to about 10.0 ml per dispensing, from about 1.0 ml to about 3.0 ml per dispensing, or from about 1.5 ml to about 2.5 ml per dispensing.

In further aspects, the device may comprise at least one container. The container may be at least one of a tank, vessel, bottle, cylinder, and cartridge, and the like. In still further aspects, the container may be replaceable. The container may be detachably connected to the device. The container may be configured to be detachably connected to the base housing and the dispensing system. In further aspects, the container may be configured to be detachably connected to the dispensing system by piercing through a container opening and/or cap. In some aspects, the container may be a 5-gallon container, which may be configured to yield at least about a 1,000-dispensing output, about a 5,000 dispensing output, at least about a 10,000 dispensing output, or even about a 11,000 dispensing output.

In further aspects, the sanitizing agent may be at least one of: hand sanitizing composition, alcohol-based sanitizing composition, antimicrobial composition, antibacterial composition, bactericidal composition, bacteriostatic composition or the like. In some aspects, the sanitizing agent is an alcohol-based sanitizing composition. In further aspects, the sanitizing agent can comprise a gel, liquid and/or solution. In other aspects, the sanitizing agent may also comprise one or more of: soap, water, a disinfecting composition, antimicrobial composition, antibacterial composition, bactericidal composition, bacteriostatic composition or the like. In some aspects, the sanitizing agent may be all natural, biodegradable, and/or non-toxic. In other aspects, the sanitizing agent may further comprise one or more fragrances. In further aspects, the sanitizing agent may be configured to kill at least 99% of microbes, mold, and bacteria, for example, at least 99.9 or 99.99%.

In still further aspect, the components can be integrally or mechanically attached to other components. In a yet further aspect, the disclosed components can be connected, attached, or mounted using a connecting means, the connecting means comprising a fitting, insert, adhesive, brazing, soldering, welding, spot weld, screw with nut, rivet, fitting, insert, threading, friction fit, or snap-fit or a combination thereof In further aspects, the device components can be attached using a connecting means. In still further aspects, the connecting means can comprise a fitting, insert, adhesive, brazing, soldering, welding, spot weld, screw with nut, rivet, threading, friction fit, snap-fit, twist-lock, or interlocking mechanism or a combination thereof. In yet further aspects, the connection can be achieved using a snap, friction fitting, snap ring, O-ring, pressure fitting, clip, clasp, and the like. The snap ring or O-ring can be retained within a groove to accommodate the snap ring or O-ring. In a further aspect, the device can comprise an engagement means for coupling and holding components together. In a further aspect, the engagement means can be a screwing mechanism, a click-lock mechanism, or friction mechanism, or the like.

### Dispensing Device and Station Configuration

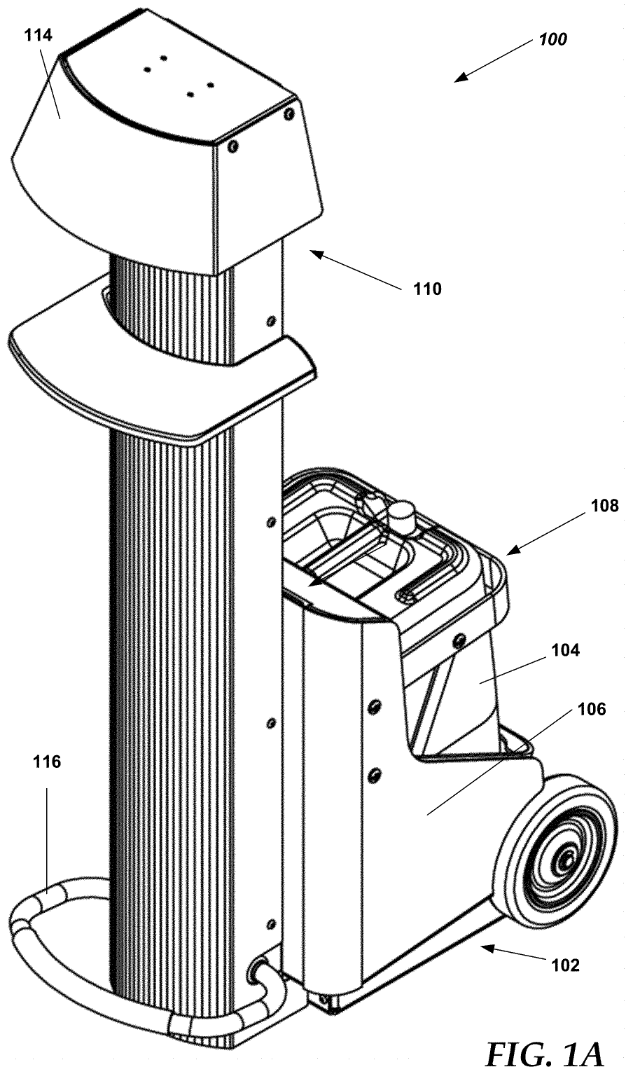

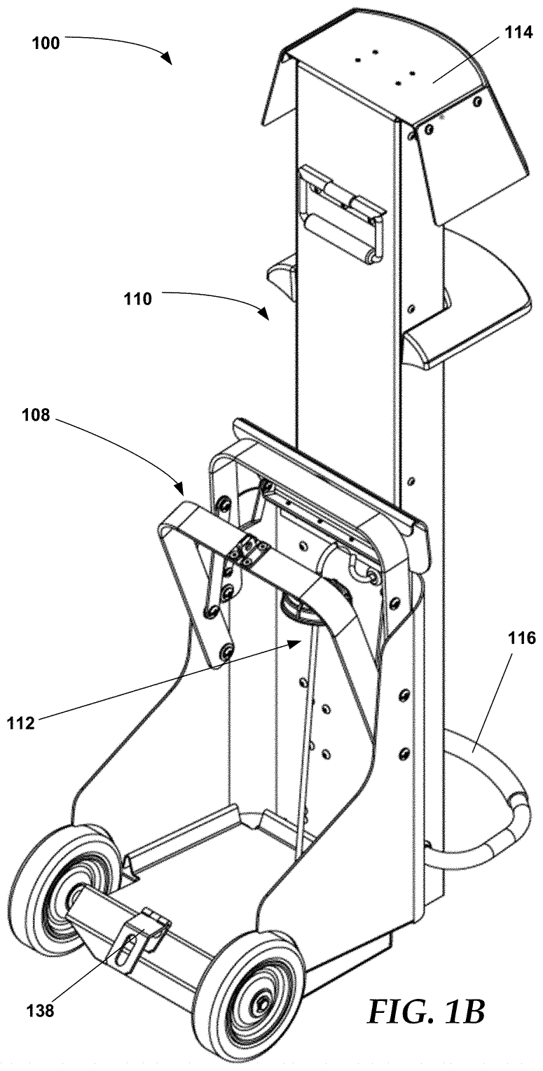

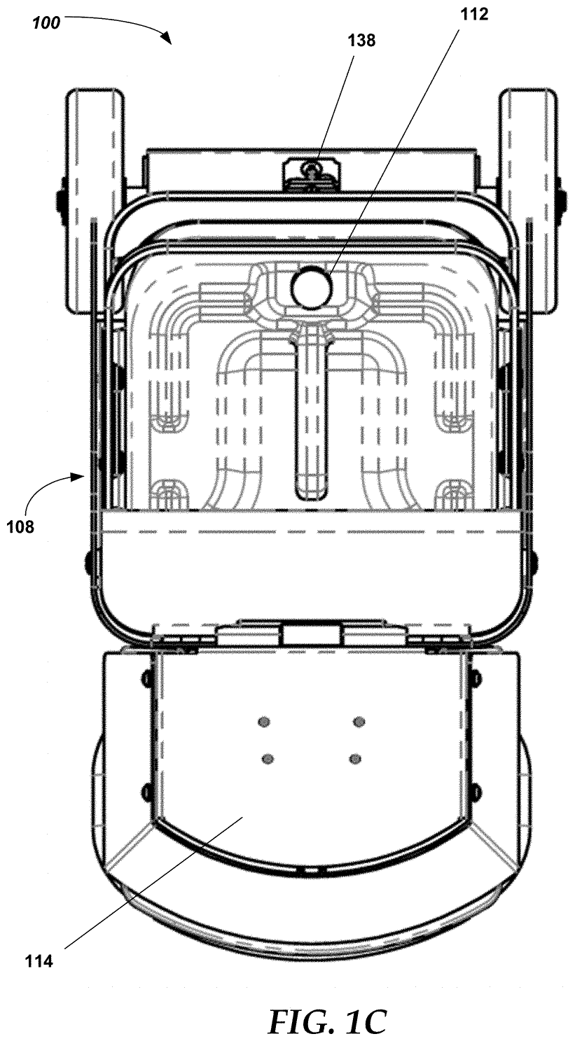

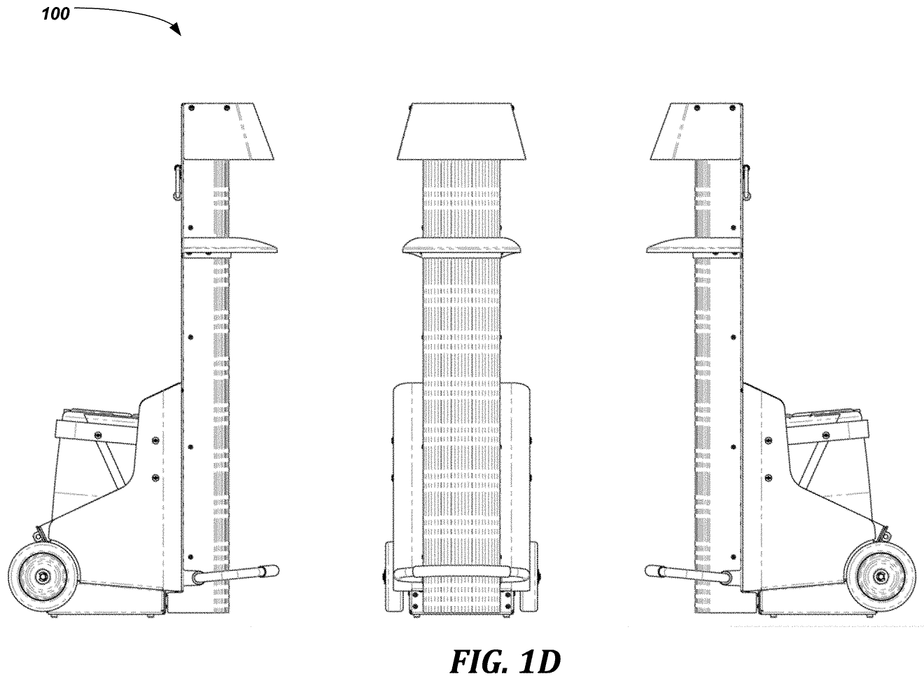

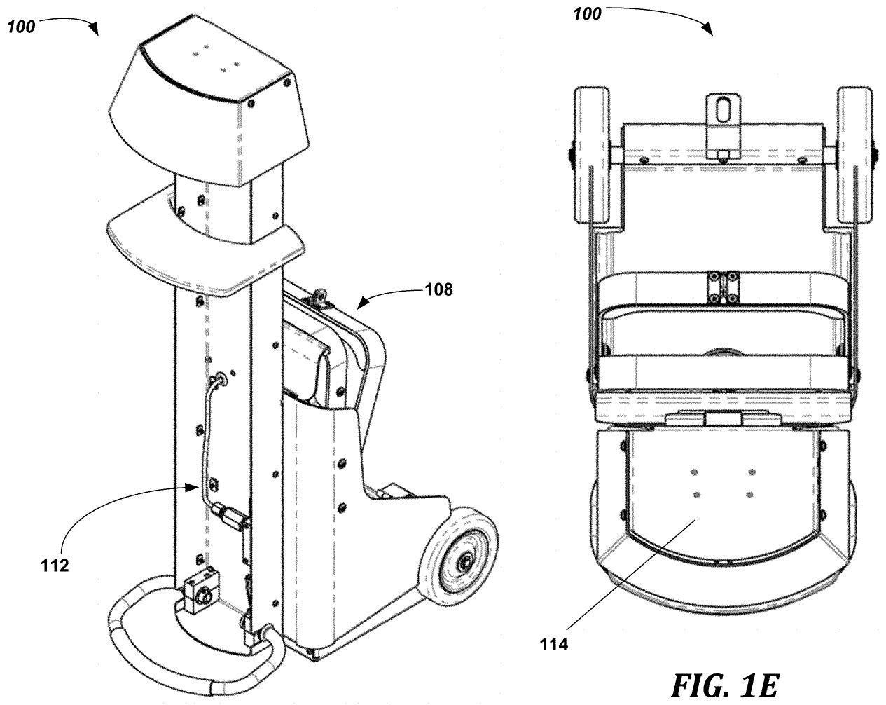

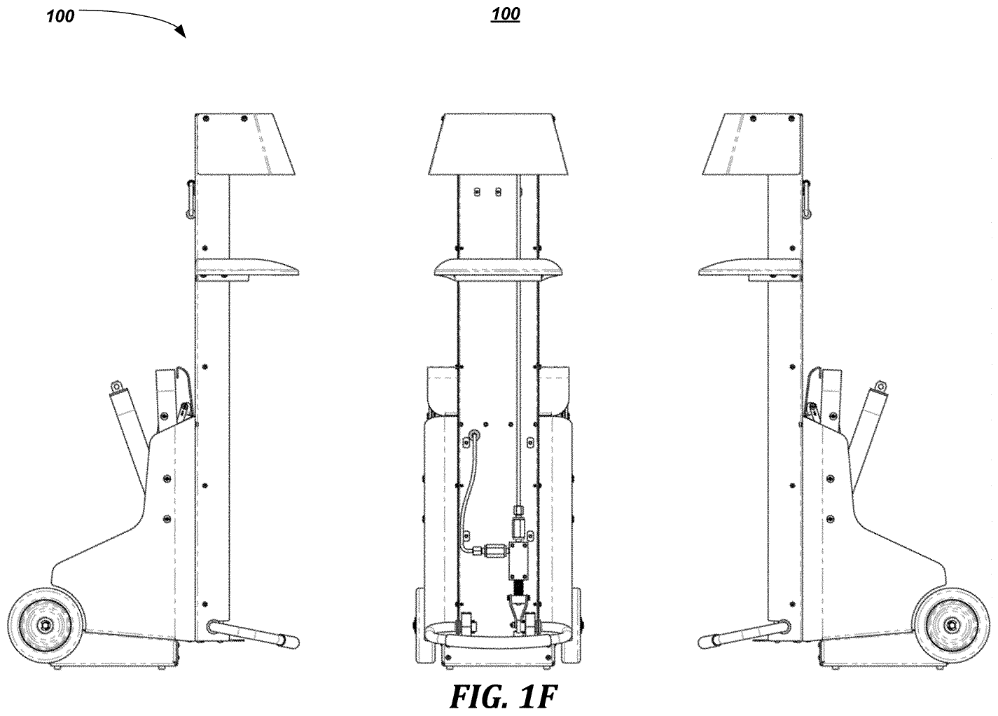

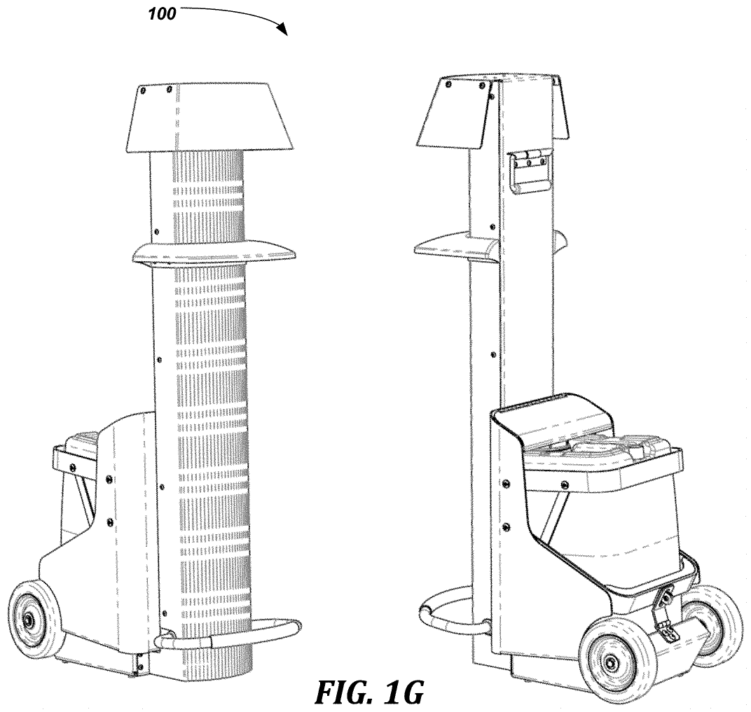

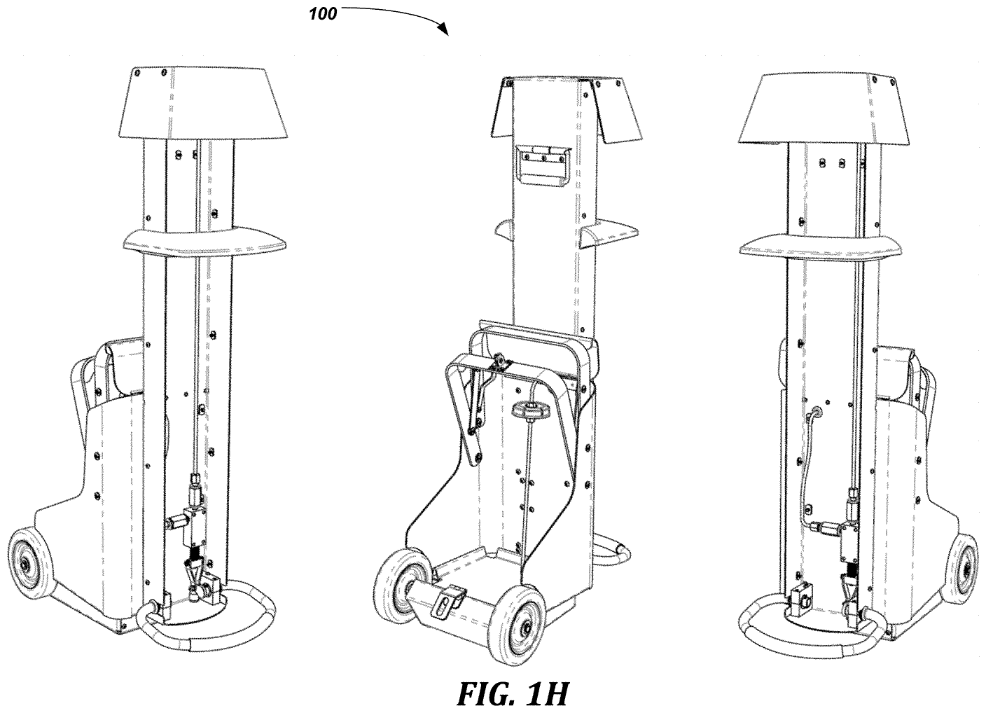

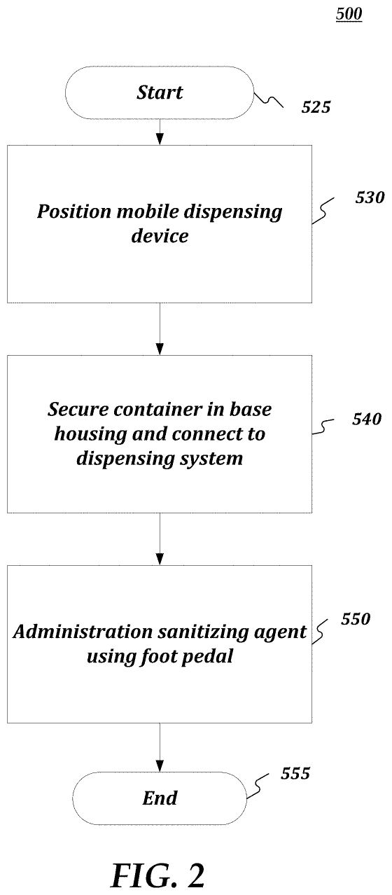

According to various aspects of the invention, the devices, stations and systems of the present disclosure can comprise multiple configurations. FIGS. 1A-1H, FIG. 2 and Appendix A illustrate non-limiting examples of embodiments of operating environments, mechanisms, and components for the disclosed devices, stations and systems. Although the operating environments, mechanisms, and components are disclosed with specific functionality, it should be understood that functionality may be shared between mechanisms and/or components, with some functions split between mechanisms and/or components, while other functions duplicated by the mechanisms and/or components. Furthermore, the name of the mechanisms and/or components should not be construed as limiting upon the functionality of the mechanisms and/or components. Moreover, each stage in the claim language can be considered independently without the context of the other stages. Each stage may contain language defined in other portions of this specifications. Each stage disclosed for one mechanism and/or component may be mixed with the operational stages of another mechanism and/or component. Each stage can be claimed on its own and/or interchangeably with other stages of other mechanisms and/or components.

FIG. 1A-FIG. 1H show various views of an illustrative embodiment of a mobile dispensing device 100 in accordance with the present disclosure. Device 100 includes a container base assembly 102 configured to releasably secure a container 104, the container base assembly comprising a base housing 106 and a securing mechanism 108 for releasably securing the container in the housing; and a dispenser column 110 comprising: a dispenser system 112 including a dispenser head 114 and foot pedal 116, the dispenser system in fluid communication with the container and configured to selectively dispense a predetermined volume of the sanitizing agent from within the container and through the dispenser head, the pedal configured to selectively dispense the sanitizing agent upon activation or actuation, and a column housing for containing the dispenser system. Device 100 in the illustrated embodiment, includes a number of orifices or opening that are operative to receive one or more suitable fasteners or supply lines from the dispensing system. The fasteners may include any type of fastener suitable for securing the components of the device together, such as, for example, through bolts, machine screws, lag bolts, wood screws, anchors, or any other suitable fastener.

Container base assembly 102 includes base pan, a base wrap, a front base pan portion, and a hinged base cover or top. The securing mechanism 108 comprises a lower rotating arm connected with the upper rotating arm by a first linking bar and upper rotating arm connected with the hinged cover by a second linking bar. The hinged cover, and lower and upper rotating arms cooperate to secure the container in the base housing. For example, when the lower or upper rotating arms are moved, the remaining components of the securing mechanism including the hinged base cover cooperatively move in the same direction. The rotating arms may be shaped and dimensioned to correspond or substantially correspond to an outer shape and dimensions of the cartridge, such as a U-shaped member illustrated in the figures. A locking mechanism 138 for locking the lower rotating arm with the front base pan portion may be incorporated to increase security and theft. The illustrated embodiment contemplates any lock device that is opened by a key, alternate exemplary embodiments may include any type of suitable of lock device, such as, for example a keyed padlock, a combination padlock, an electronic lock, a fastener(s) with tamper resistant features, or a lock that accepts a special tool as opposed to a key. The base may also comprise an axle tube, with two wheels connected by an axle for moving the device around, similar to a dolly or hand truck.

The dispenser column may comprise a dispensing system and dispenser head, which are contained in a housing in the form of a U-shaped channel with cover. The dispenser column height may be from about 24 to about 48 inches, where the dispenser head is from about 24 to about 48 inches from the ground, such as, for example, from about 30 to about 36 inches from the ground. The dispenser column height may be adjustable, such as through a telescoping construction or the like. A spray shield, such as a flexible casing, may can be positioned over the dispensing head and splash guard may be located on the column below it to prevent splashing and spillage.

The dispenser head is configured to dispense a predetermined volume or quantity of agent from within the container when the foot pedal is activated. The dispenser head is in operable communication with the dispensing system, which is configured to dispense sanitizing agent within the container to be drawn or pulled into and out of the dispenser head. The dispenser head may comprise a flow control component or nozzle for controlling the flow or form of sanitizing agent begin dispensed, such as an atomizing nozzle or component for dispensing the sanitizing agent as a volume of foam. The nozzle or flow control component may be configured to control a flow rate and/or volume and/or ratio of mixed air/sanitizing agent. The flow control component may be a nozzle or nozzle insert.

The dispensing system may include one or more of a pump, supply lines, and components for dispensing the sanitizing agent from within container. The dispensing system may include a container cap with supply line traveling therethrough for picking up or pulling the sanitizing agent from the container. The dispensing system is in operable communication with the foot pedal, which is configured to dispense sanitizing agent within the container when actuated. In some aspects, pedal can be a switch, toggle, lever, or other like mechanism. The disclosure herein contemplates any type of actuating switch or pedal that would be practical with dispensing a sanitizing agent.

Though the illustrated embodiments include a device that is fabricated substantially from a metal such as, for example, steel, other exemplary embodiments may include any type of material or combination of materials such as, for example, metal, plastic, wood, rubber, polymer materials, composite materials, fabric, nylon, webbing, or cordage.

In at least one embodiment, the disclosed devices and stations can include one or more of the following components:

TABLE 1

| ITEM NO. | PART NUMBER |
|---|---|
| 1 | Han San Station_Base - Wrap |
| 2 | 5 Gallon Container |
| 3 | 6 in Wheel - MMC 2331T11 |
| 4 | Base Pan - Front |
| 5 | Locking Structure - Lower Arm |
| 6 | Locking Structure - Upper Arm |
| 7 | Locking Structure - Long Linkage Bar |
| 8 | Locking Structure - Door Flap Linkage Bar |
| 9 | Sprayer Channel - Inner Frame |
| 10 | Sprayer Channel - Outer Cover |
| 11 | Spray Shield v2 - Formed Plastic |
| 12 | HSS Pump Assembly |
| 13 | Foot Pedal Pivot Block |
| 24 | 1546A600_PADLOCKABLE HASP_Strike Plate |
| 25 | 1764A310_SPRING-LOADED SURFACE-MOUNT |
| | FOLDING PULL HNDL |
| 25 | Axle |
| 41 | Spray Guard Shelf - Plastic |
| 42 | Upper Nozzle Bracket |
| 43 | 5388K14 |
| 44 | .75 dia × .125 Spacer |
| 45 | Door Panel - Hinged |
| 46 | Foot Pedal Bar - Sub Assembly |
| 47 | Cap - Pickup Tube |

Also disclosed herein are methods of using the disclosed devices, stations and systems, such as shown in FIG. 2. For example, in one aspect, the present disclosure provides a method for dispensing a sanitizing agent using a disclosed dispensing device or station. In further aspects, the method may comprise installing a container having a sanitizing composition or agent into a dispensing device of any preceding claim; and/or depressing the switch or foot pedal to dispense a predetermined quantity or volume of sanitizing agent into a user's hand.

The present invention includes at least the following aspects: Aspect 1: A mobile dispensing device for dispensing a sanitizing agent, the device comprising: a container base [or base assembly] configured to releasably secure a container, the container base assembly comprising a base housing and a securing mechanism for releasably securing the container in the housing; and a dispenser column comprising: a dispenser system including a dispenser head and switch or pedal, the dispenser system in fluid communication with the container and configured to selectively dispense a predetermined volume of the sanitizing agent from within the container and through the dispenser head, the switch configured to selectively dispense the sanitizing agent upon activation or actuation, and a column housing for containing the dispenser system.

Aspect 2: A mobile sanitizing station comprising: a mobile dispensing device for dispensing a sanitizing agent, the device comprising: a container base assembly configured to releasably secure a container, the container base assembly comprising a base housing including wheels and a securing mechanism for releasably retaining the container in the container base housing; a dispenser column comprising: a dispenser system including a dispenser head and a pedal, the dispenser system in fluid communication with the container and configured to selectively dispense a predetermined volume of the sanitizing agent from within the container and through the dispenser head, the foot pedal configured to selectively dispense the sanitizing agent upon activation or actuation, and a column housing for containing the dispenser system; and a container or compartment configured to hold a sanitizing agent and/or cleaning agent.

Aspect 3: The device of any preceding claim, further comprising a container or compartment comprising a sanitizing and/or sanitizing agent.

Aspect 4: The device of any preceding claim, wherein the housing comprises one or more of: a base pan, a base wrap, a front base pan portion, or a base cover or top, and combinations thereof.

Aspect 5: The device of any preceding claim, wherein the securing mechanism comprises at least one rotating arm.

Aspect 6: The device of any preceding claim, wherein the securing mechanism comprises a plurality of rotating arms.

Aspect 7: The device of any preceding claim, wherein the securing mechanism comprises at least one rotating or hinged cover.

Aspect 8: The device of any preceding claim, wherein the securing mechanism comprises at a plurality of rotating arms are connect by one or more linking bars.

Aspect 9: The device of any preceding claim, wherein the securing mechanism comprises a hinged cover, and lower and upper rotating arms.

Aspect 10: The device of any preceding claim, wherein lower rotating arm is connected with the upper rotating arm by a first linking bar and the upper rotating arm is connected with the hinged cover by a second linking bar.

Aspect 11: The device of any preceding claim, wherein the hinged cover, and lower and upper rotating arms cooperate to secure the container in the base housing.

Aspect 12: The device of any preceding claim, wherein when the lower or upper rotating arms are moved, the remaining components of the securing mechanism cooperatively move in the same direction.

Aspect 13: The device of any preceding claim, wherein the rotating arm is shaped and dimensioned to correspond or substantially correspond to an outer shape and dimensions of the cartridge.

Aspect 14: The device of any preceding claim, wherein the rotating arm is a U-shaped member.

Aspect 15: The device of any preceding claim, further comprising locking mechanism for locking the lower rotating arm with the front base pan portion.

Aspect 16: The device of any preceding claim, further comprising wheels.

Aspect 17: The device of any preceding claim, wherein the switch is a foot pedal effective to cause at least a portion of the sanitizing agent within the container to be drawn [or pulled] into the dispenser system and out of the dispenser head.

Aspect 18: The device of any preceding claim, wherein the switch or pedal comprises foot pedal.

Aspect 19: The device of any preceding claim, wherein the switch comprises an actuating mechanism.

Aspect 20: The device of any preceding claim, wherein the dispenser column height is adjustable.

Aspect 21: The device of any preceding claim, wherein the dispenser column height is from about 24 to about 48 inches.

Aspect 22: The device of any preceding claim, wherein the dispenser head is from about 24 to about 48 inches from the ground.

Aspect 23: The device of any preceding claim, wherein the dispenser head is from about 30 to about 36 inches from the ground.

Aspect 24: The device of any preceding claim, further comprising a least one guard disposed on the dispenser column.

Aspect 25: The device of any preceding claim, further comprising a plurality of guards disposed on the dispenser column.

Aspect 26: The device of any preceding claim, wherein at least one guard disposed on the dispenser column is configured to prevent accidental splashing in children's faces.

Aspect 27: The device of any preceding claim, the dispensing system further comprising at least supply line configured to carry sanitizing agent from within the container into dispenser head.

Aspect 28: The device of any preceding claim, wherein the supply line is in fluid communication with the sanitizing agent.

Aspect 29: The device of any preceding claim, the dispensing system further comprising a container cap with pick up supply line traveling therethrough.

Aspect 30: The device of any preceding claim, wherein the device is configured to tilt the container effective to move the sanitizing agent towards the supply line and/or pick-up hose.

Aspect 31: The device of any preceding claim, wherein the container comprises at least one of a tank, vessel, bottle, cylinder, and cartridge, and the like.

Aspect 32: The device of any preceding claim, wherein the container is replaceable.

Aspect 33: The device of any preceding claim, wherein the container is detachably connected to the device.

Aspect 34: The device of any preceding claim, wherein the container is configured to be detachably connected to the base housing and the dispensing system.

Aspect 35: The device of any preceding claim, wherein the container is configured to be detachably connected to the dispensing system by piercing through a container opening and/or cap.

Aspect 36: The device of any preceding claim, wherein the container is a 5-gallon container.

Aspect 37: The device of any preceding claim, wherein the 5-gallon container is configured to yield at least about 1,000 dispensing output.

Aspect 38: The device of any preceding claim, wherein the 5-gallon container is configured to yield at least about 5,000 dispensing output.

Aspect 39: The device of any preceding claim, wherein the 5-gallon container is configured to yield at least about 10,000 dispensing output.

Aspect 40: The device of any preceding claim, wherein the 5-gallon container is configured to yield at least about 11,000 dispensing output.

Aspect 41: The device of any preceding claim, further comprising a flow control component in fluid communication with the container, and configured to control a flow rate or volume of sanitizing agent dispensed.

Aspect 42: The device of any preceding claim, wherein the dispensing head comprises an atomizing-type nozzle.

Aspect 43: The device of any preceding claim, wherein the device is configured to dispense atomized sanitizing agent.

Aspect 44: The device of any preceding claim, wherein the device is configured to dispense foaming sanitizing agent.

Aspect 45: The device of any preceding claim, wherein the sanitizing agent comprises at least one of: hand sanitizing composition, alcohol-based sanitizing composition, antimicrobial composition, antibacterial composition, bactericidal composition, bacteriostatic composition or the like.

Aspect 46: The device of any preceding claim, wherein the sanitizing agent is an alcohol-based sanitizing composition.

Aspect 47: The device of any preceding claim, wherein the device is configured to dispense from about 0.1 ml to about 10.0 ml per dispensing.

Aspect 48: The device of any preceding claim, wherein the device is configured to dispense from about 1.0 ml to about 3.0 ml per dispensing.

Aspect 49: The device of any preceding claim, wherein the device is configured to dispense from about 1.5 ml to about 2.5 ml per dispensing.

Aspect 50: A method for effective hand sanitizing, the method comprising: installing a container having a sanitizing composition or agent into a dispensing device of any preceding claim; and depressing the switch to dispense a predetermined quantity or volume of sanitizing agent into a user's hand.

While aspects of the present disclosure can be described and claimed in a particular statutory class, such as the system statutory class, this is for convenience only and one of skill in the art will understand that each aspect of the present disclosure can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way appreciably intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

Throughout this application, various publications can be referenced. The disclosures of these publications in their entireties are hereby incorporated by reference into this application in order to more fully describe the state of the art to which this pertains. The references disclosed are also individually and specifically incorporated by reference herein for the material contained in them that is discussed in the sentence in which the reference is relied upon. Nothing herein is to be construed as an admission that the present disclosure is not entitled to antedate such publication by virtue of prior disclosure. Further, the dates of publication provided herein can be different from the actual publication dates, which can require independent confirmation.

The patentable scope of the disclosure is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

While the specification includes examples, the disclosure's scope is indicated by the following claims. Furthermore, while the specification has been described in language specific to structural features and/or methodological acts, the claims are not limited to the features or acts described above. Rather, the specific features and acts described above are disclosed as example for embodiments of the disclosure.

Insofar as the description above and the accompanying drawing disclose any additional subject matter that is not within the scope of the claims below, the disclosures are not dedicated to the public and the right to file one or more applications to claims such additional disclosures is reserved. Although very narrow claims are presented herein, it should be recognized the scope of this disclosure is much broader than presented by the claims.

What is claimed is:

1. A mobile dispensing device for dispensing a sanitizing agent, the device comprising:
a. a container base configured to releasably secure a container, the container base comprising a base housing and a securing mechanism for releasably securing the container in the base housing; and
b. a dispenser column comprising: a dispenser system including a dispenser head and switch, the dispenser system in fluid communication with the container and configured to selectively dispense a predetermined volume of the sanitizing agent from within the container and through the dispenser head, the switch configured to selectively dispense the sanitizing agent upon activation or actuation, and a column housing for containing the dispenser system.

2. The device of claim 1, further comprising a removable container configured to hold a sanitizing agent.

3. The device of claim 2, wherein the base housing comprises a base pan, a base wrap, a front base pan portion, and a base cover or top.

4. The device of claim 1, wherein the securing mechanism comprises a plurality of rotating arms.

5. The device of claim 4, wherein the securing mechanism further comprises at least one hinged cover.

6. The device of claim 4, wherein the plurality of rotating arms are connected by one or more linking bars.

7. The device of claim 6, wherein the securing mechanism comprises a hinged cover, and lower and upper rotating arms.

8. The device of claim 7, wherein the lower rotating arm is connected with the upper rotating arm by a first linking bar and the upper rotating arm is connected with the hinged cover by a second linking bar; and wherein the hinged cover, and lower and upper rotating arms cooperate to secure the container in the base housing.

9. The device of claim 8, wherein when the lower or upper rotating arms are moved, the remaining components of the securing mechanism cooperatively move in the same direction.

10. The device of claim 9, wherein the rotating arm is shaped and dimensioned to correspond to an outer shape and dimensions of the container.

11. The device of claim 10, further comprising locking mechanism for locking the lower rotating arm with the front base pan portion.

12. The device of claim 11, further comprising wheels.

13. The device of claim 12, wherein the switch is a foot pedal effective to cause at least a portion of the sanitizing agent within the container to be drawn into the dispenser system and out of the dispenser head.

14. The device of claim 13, wherein the dispenser column height is adjustable.

15. The device of claim 14, wherein the base housing is configured to tilt the container effective to move the sanitizing agent towards a supply line pick-up hose.

16. A mobile sanitizing station comprising:
a mobile dispensing device for dispensing a sanitizing agent, the device comprising:
a container base assembly configured to releasably secure a container, the container base assembly comprising a base housing including wheels and a securing mechanism for releasably retaining the container in the container base housing;
a dispenser column comprising: a dispenser system including a dispenser head and a pedal, the dispenser system in fluid communication with the container and configured to selectively dispense a predetermined volume of the sanitizing agent from within the container and through the dispenser head, the foot pedal configured to selectively dispense the sanitizing agent upon activation or actuation, and a column housing for containing the dispenser system; and
a removable container configured to hold a sanitizing agent or cleaning agent;
wherein the securing mechanism comprises a hinged cover, and lower and upper rotating arms;
wherein the lower rotating arm is connected with the upper rotating arm by a first linking bar and the upper rotating arm is connected with the hinged cover by a second linking bar;
wherein the hinged cover, and lower and upper rotating arms cooperate to secure the container in the base housing; and
wherein when the lower or upper rotating arms are moved, the remaining components of the securing mechanism cooperatively move in the same direction.

17. The station of claim 16, wherein the rotating arms are U-shaped members.

18. The station of claim 17, further comprising locking mechanism for locking the lower rotating arm with a front base pan portion of the base housing.

19. The station of claim 18, wherein the device is configured to tilt the container effective to move the sanitizing agent towards a supply line pick-up hose.

20. The station of claim 19, wherein the container is configured to be detachably connected to the dispensing system by piercing through a container cap or seal.
